(19) United States
(12) Patent Application Publication
(10) Pub. No.: US 2018/0225888 A1
(43) Pub. Date: Aug. 9, 2018

(54) SYSTEMS AND METHODS FOR EMPLOYEE TIME RECORDING

(71) Applicant: Wal-Mart Stores, Inc., Bentonville, AR (US)

(72) Inventors: Steven Jackson Lewis, Bentonville, AR (US); Nicholaus Adam Jones, Fayetteville, AR (US); Matthew Dwain Biermann, Fayetteville, AR (US)

(21) Appl. No.: 15/883,396

(22) Filed: Jan. 30, 2018

Related U.S. Application Data
(60) Provisional application No. 62/455,911, filed on Feb. 7, 2017.

(51) Int. Cl. G07C 1/14; G07C 9/00

(52) U.S. Cl. CPC G07C 1/14; G07C 9/00119; G07C 9/00111; G07C 9/00079

(57) ABSTRACT

A time record system for automatically determining a status of an employee is discussed. The time record system includes multiple image sensing devices to detect a visual indicator that uniquely identifies an employee. The time record system also includes a processing device to create and store an event and a timestamp in response to detection of the visual indicator. A second event is created and stored along with a timestamp in response to occurrence of a second detection of the visual indicator by the image sensing devices. The status of the employee is determined based on the stored events and a signal is transmitted to a wearable device associated with the employee.

### RELATED APPLICATION

This application claims priority to U.S. Provisional Application No. 62/455,911 filed on Feb. 2, 2017, the content of which is hereby incorporated by reference in its entirety.

### BACKGROUND

Business entities or facilities in general employ numerous employees that have varying job descriptions and work schedules. Employees can also have varying break schedules while at work. During a particular work shift an employee may be assigned periods of time in which to take a break.

### SUMMARY

In one embodiment, an employee time record system is provided for determining a status of an employee. The system includes multiple image sensing devices positioned at one or more locations in a physical facility. The system also includes a visual indicator affixed to clothing uniquely identifying an employee, and a processor in a processing device in communication with the plurality of image sensing devices. The image sensing devices are configured to detect the visual indicator. The processing device is configured to create and store a first event in a database in response to a first detection of the visual indicator. The first event indicates the first detection of the visual indicator by at least one of the image sensing devices and a timestamp for when the first detection occurred. The processing device is also configured to monitor for occurrence of a second detection of the visual indicator by one of the image sensing devices, where the second detection occurs after the first detection. The processing device is configured to create and store a second event in the database in response to the second detection. The second event indicates the second detection of the visual indicator by at least one of the image sensing devices and a timestamp for when the second detection occurred. The processing device is further configured to determine a status of the employee identified by the visual indicator based at least in part on an occurrence of at least one of the first event and the second event, and transmit a signal to a wearable device associated with the employee indicating the status determined for the employee.

In another embodiment, a method for determining a status of an employee in an employee time record system is provided. The method includes disposing multiple image sensing devices at one or more locations in a physical facility, and affixing a visual indicator to clothing uniquely identifying an employee. The method also includes detecting the visual indicator by one of the image sensing devices, and creating and storing a first event in a database in response to a first detection of the visual indicator. The first event indicates the first detection of the visual indicator by at least one of the image sensing devices and a timestamp for when the first detection occurred. The method further includes monitoring for occurrence of a second detection of the visual indicator by one of the image sensing devices, where the second detection occurs after the first detection. The method includes creating and storing a second event in a database in response to the second detection of the visual indicator. The second event indicates the second detection of the visual indicator by at least one of the image sensing devices and a timestamp for when the second detection occurred. The method further includes determining a status of the employee identified by the visual indicator based at least in part on an occurrence of at least one of the first event and the second event, and transmitting a signal to a wearable device associated with the employee indicating the status determined for the employee.

In yet another embodiment, a non-transitory computer readable medium is provided that stores instructions that when executed by a processor causes the processor to implement a method for determining a status of an employee in an employee time record system. The method includes disposing multiple image sensing devices at one or more locations in a physical facility, and affixing a visual indicator to clothing uniquely identifying an employee. The method also includes detecting the visual indicator by one of the image sensing devices, and creating and storing a first event in a database in response to a first detection of the visual indicator. The first event indicates the first detection of the visual indicator by at least one of the image sensing devices and a timestamp for when the first detection occurred. The method further includes monitoring for occurrence of a second detection of the visual indicator by one of the image sensing devices, where the second detection occurs after the first detection. The method includes creating and storing a second event in a database in response to the second detection of the visual indicator. The second event indicates the second detection of the visual indicator by at least one of the image sensing devices and a timestamp for when the second detection occurred. The method further includes determining a status of the employee identified by the visual indicator based at least in part on an occurrence of at least one of the first event and the second event, and transmitting a signal to a wearable device associated with the employee indicating the status determined for the employee.

### BRIEF DESCRIPTION OF THE DRAWINGS

The accompanying drawings, which are incorporated in and constitute a part of this specification, illustrate one or more embodiments of the present invention and, together with the description, help to explain the present invention. The embodiments are illustrated by way of example and should not be construed to limit the present invention. In the drawings:

FIG. 1 is a block diagram showing an exemplary time record system, according to an example embodiment;

FIG. 2 is a flowchart illustrating an exemplary method for determining a status of an employee in the time record system, according to an example embodiment;

FIG. 3 schematically depicts an exemplary time record system, according to an example embodiment;

FIG. 4 is a diagram of an exemplary network environment suitable for a distributed implementation of exemplary embodiments; and

FIG. 5 is a block diagram of an exemplary computing device that may be used to implement exemplary embodiments described herein.

### DETAILED DESCRIPTION

It is difficult to keep track of an employee's status, and determine who is on the clock or who is on break. Also, employees may forget to clock-in or clock-out causing inaccuracies in their employee time records. Systems, methods and computer readable medium are described herein for a time record system for determining a status of an employee. In one embodiment, the time record system includes a visual indicator that uniquely identifies an employee and is affixed to the employee's clothing. Multiple image sensing devices are disposed at various locations within a facility. The image sensing devices detect or sense the visual indicator, and create and store an event based on the detection. The event may include the location of the detection and time of detection. The time record system also monitors for another (second) detection of the visual indicator. When the visual indicator is subsequently detected by the image sensing devices, the time record system determines the status of the employee associated with the visual indicator based at least in part on the detections of the visual indicator. In this manner, the time record system can track movement of an employee within the facility and determine a status of the employee. The time record system further transmits a feedback or acknowledgement signal to a wearable device worn by the employee to indicate to the employee that his or her status has been updated or that the visual indicator has been detected.

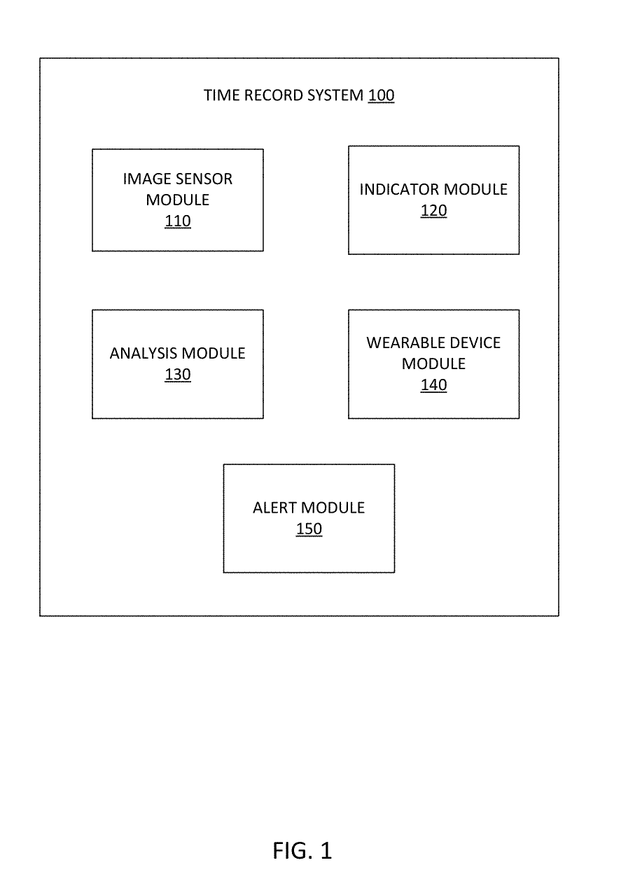

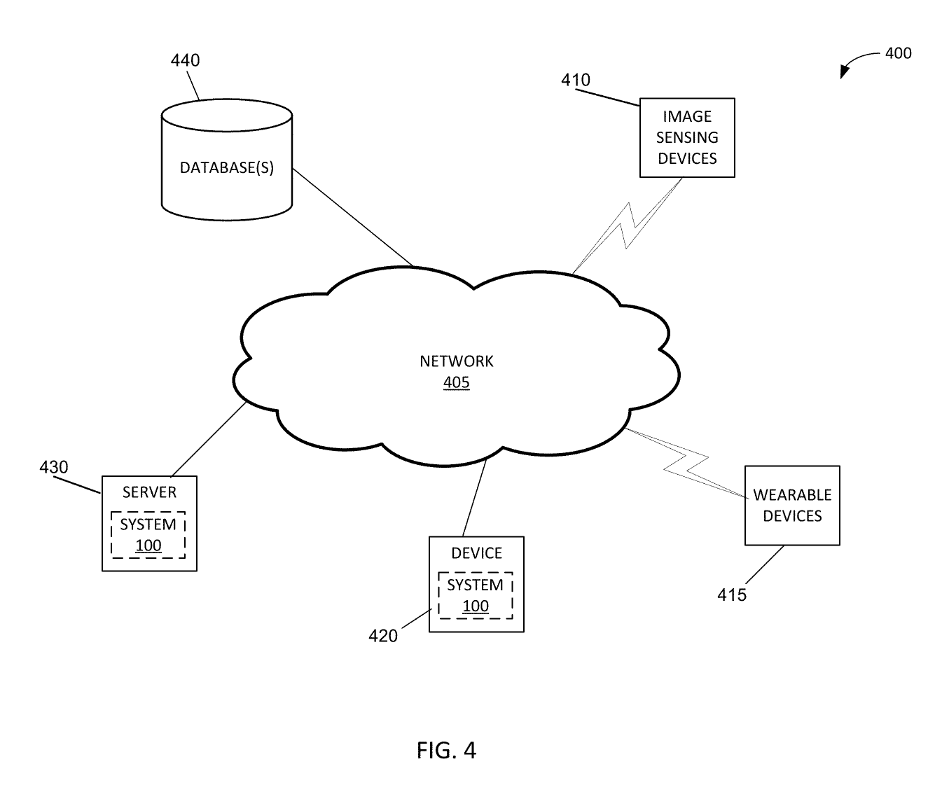

FIG. 1 is a block diagram showing a time record system 100 in terms of modules for determining a status of an employee, according to an example embodiment. The one or more of the modules may be implemented in server 430 shown in FIG. 4. The modules include an image sensor module 110, an indicator module 120, an analysis module 130, a wearable device module 140, and an alert module 150. The modules may include various circuits, circuitry and one or more software components, programs, applications, or other units of code base or instructions configured to be executed by one or more processors (e.g., processors included in a device 420 or a server 430 shown in FIG. 4). In other embodiments, one or more of modules 110, 120, 130, 140, 150 may be included in a device (e.g., device 420 shown in FIG. 4), while other of the modules 110, 120, 130, 140, 150 are provided in a server (e.g., server 430 shown in FIG. 4). Although modules 110, 120, 130, 140, 150 are shown as distinct modules in FIG. 1, it should be understood that modules 110, 120, 130, 140, and 150 may be implemented as fewer or more modules than illustrated. It should be understood that one or more of modules 110, 120, 130, 140, and 150 may communicate with one or more components included in exemplary embodiments of the present disclosure (e.g., image sensing devices 410, wearable devices 415, device 420, server 430, or database(s) 440 of system 400 shown in FIG. 4).

The image sensor module 110 may be configured to manage image sensing devices disposed in a facility, and store location of each image sensing device in a database. The image sensor module 110 may also be configured to receive and manage data sensed or detected by the image sensing devices.

The indicator module 120 may be configured to maintain data related to each visual indicator affixed to an employee's clothing. The indicator module 120 may also be configured to store and retrieve employee information associated with a visual indicator so as to identify an employee associated with the visual indicator detected by one or more image sensing devices.

The analysis module 130 may be configured to analyze data sensed or detected by the image sensing devices, and to create and store events based on detection of a visual indicator. The analysis module 130 may also be configured to monitor for detection of visual indicators, and determine a status for an employee associated with a visual indicator.

The wearable device module 140 may be configured to manage and maintain a record of wearable devices and an employee associated with each wearable device. The wearable device module 140 may also be configured to identify a wearable device associated with an employee. In an example embodiment, wearable devices include, but are not limited to, security badges, name badges, smartwatches, fitness trackers and devices, and other wearable computing devices. In one embodiment the wearable device module 140 may transmit a signal to the wearable device indicating the status determined for the employee.

The alert module 150 may be configured to manage alerts generated in response to non-detection of a visual indicator, and to transmit alerts to a device or server. In an example embodiment, the alert module 150 transmits an alert to a wearable device of an employee.

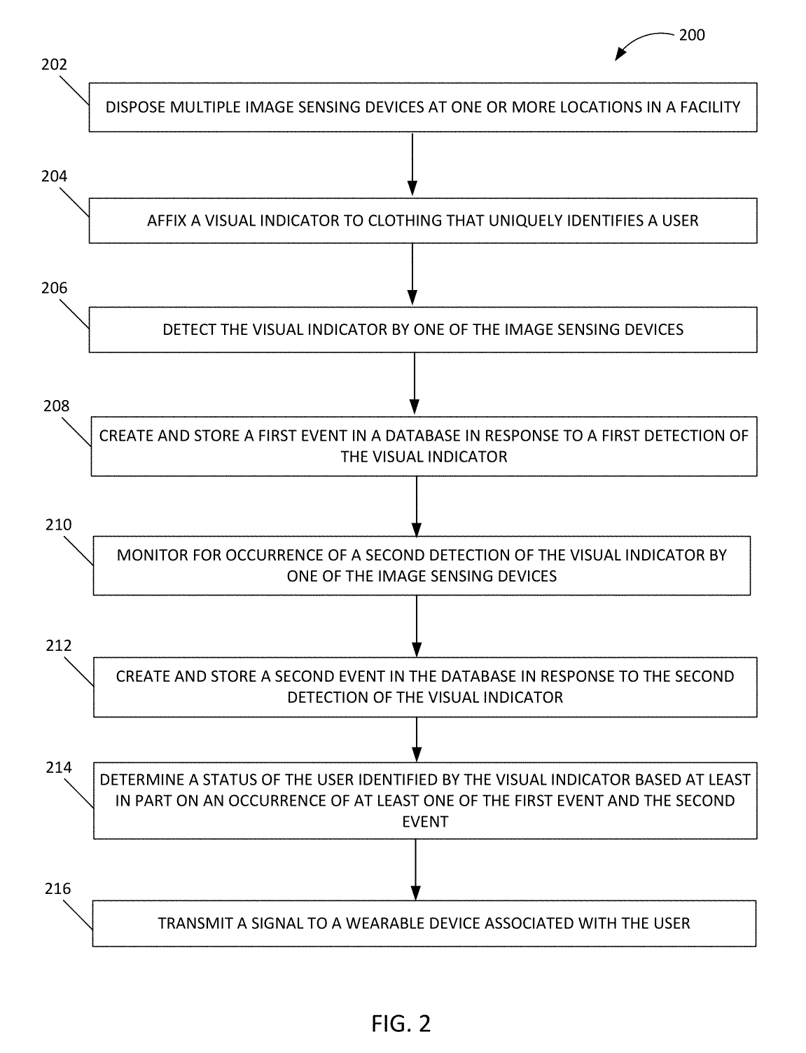

FIG. 2 is a flowchart illustrating an exemplary method 200 for determining a status of an employee in the time record system, according to an example embodiment. The method 200 may be performed using one or more modules of the time record system 100 described above.

At step 202, multiple image sensing devices are disposed at one or more locations in a facility. The image sensor module 110 receives and stores a location of each image sensing device within the facility. In an example embodiment, the image sensing devices are configured to detect a visual indicator. The image sensing devices are in communication with a processing device, for example device 420 or server 430.

In an example embodiment, the image sensing devices are disposed at the entrances or exits of the facility. The image sensing devices may also be disposed at the entrance or exit of various rooms, such as a break room, a kitchen, a stock room, an employee-only area, and other areas that an employee may enter or exit. The image sensing devices may be positioned in a manner best suitable to detect a visual indicator affixed to an employee's clothing. For example, the image sensing device may be positioned on a wall at a height that is capable of detecting a visual indicator affixed to a shoulder or chest of an employee.

At step 204 a visual indicator is affixed to clothing that uniquely identifies an employee. The clothing and the visual indicator are assigned to an employee, and the employee wears the clothing while “on the job.” In an example embodiment, the visual indicator is a holographic image. In another embodiment, the visual indicator is a light-reflective patch. In yet another embodiment, the visual indicator is a patch made of light reflective thread that sewn in a unique pattern. Each employee wears a unique visual indicator by which the employee can be identified.

The visual indicator is affixed to an employee's clothing in a manner that is best suitable for detection by an image sensing device. For example, the visual indicator may be affixed to an employee's shoulder or chest.

At step 206, the image sensor module 110 detects the visual indicator on the clothing via one or more of the multiple image sensing devices disposed in the facility. An employee may walk past an image sensing device in the facility, and the image sensing device detects the visual indicator affixed to the employee's clothing. In another embodiment, an employee may stand in front of the image sensing device to scan his or her visual indicator.

At step 208, the analysis module 130 creates and stores a first event in a database (e.g., database(s) 440) in response to a first detection of the visual indicator. The first event may include a time of the first detection of the visual indicator, a location of the first detection (based on the location of the image sensing device that detected the visual indicator), a name associated with the employee identified by the visual indicator, and other data. The location of detection may be determined based on the data stored by the image sensor module 110. The employee name may be determined based on the data stored by the indicator module 120.

At step 210, the analysis module 130 monitors for occurrence of a second detection of the visual indicator by one or more of the multiple image sensing devices disposed in the facility. In an example embodiment, the monitoring for a second detection is triggered by the creation of the first event.

At step 212, the analysis module 130 creates and stores a second event in the database in response to a second detection of the visual indicator by one or more of the image sensing devices disposed in the facility. The second event may include a time of the second detection of the visual indicator, a location of the second detection (based on the location of the image sensing device that detected the visual indicator), a name associated with the employee identified by the visual indicator, and other data. The location of detection may be determined based on the data stored by the image sensor module 110. The employee name may be determined based on the data stored by the indicator module 120.

At step 214, the analysis module 130 determines a status of the employee identified by the visual indicator based at least in part on the first event and/or the second event stored by the analysis module. The analysis module may also consider other criteria in addition to the first occurrence and second occurrence such as a job title of the employee, The status of the employee indicates an on-job status of the employee. For example, the analysis module 130 determines whether an employee is clocked-in or clocked-out, or whether an employee is on break. The analysis module 130 may determine that an employee is clocked-in based on detection of his or her visual indicator at an image sensing device located at the entrance of the facility. The analysis module 130 may determine that an employee is clocked-out based on detection of his or her visual indicator at an image sensing device located at the exit of the facility.

The analysis module 130 may determine that an employee is on break based on detection of his or her visual indicator at an image sensing device located at the entrance of a break room or kitchen or other such designated areas. The analysis module 130 may determine that the employee is not on break based even though the employee's visual indicator is detected at a break designated area, based on occurrence of a second detection indicating the employee exiting the break designated area. For example, an employee may enter a break designated area for a brief period of time (to grab a quick drink of water for example), and exit within a few minutes. In some embodiments, the detection of the first event and the second event in this case would not be recorded as a status of on-break for the employee based on an amount of elapsed time between detections and pre-determined criteria accessible to the analysis module 130.

In another embodiment, the analysis module 130 may determine if the employee is located in an appropriate part of the facility, that is, the employee is working where he or she should be based on their job title. For example, an employee may be scheduled to work in the stock room, and the analysis module 130 determines if the employee is in the stock room based on the first event and/or the second event (e.g., either the first event or the second event indicates entry into the stock room).

In an example embodiment, the database may include a set of events and an order for detection of certain events, and the status associated for the events. These set of events may include a particular location of image sensing devices. The analysis module 130 may compare the created first event and the second event with the set of events and the order for detection in the database to determine the status of an employee.

In an example embodiment, the analysis module 130 determines the status of the employee based on the location of the first and second detection of the visual indicator. In an example embodiment, the database stores employee information including a name and a job title for the employee. The analysis module 130 determines the status of the employee based on the job title of the employee. In yet another example embodiment, the analysis module 130 determines the status of the employee based on the time elapsed between the detection of the first event and the detection of the second event.

In one embodiment, the status of the employee is recorded in a database, and may be recorded as clocked-in, clocked-out, or on-break.

At step 216, the analysis module 130 or the wearable device module 140 transmits a signal to a wearable device associated with the employee identified by the visual indicator. For example, in one embodiment, the signal may be transmitted by the image sensing device to the wearable device. In another embodiment, the signal may be transmitted by the device 420 or the server 430 to the wearable device. The signal may cause a light circuit to activate at the wearable device, and to provide confirmation to the employee that his or her visual indicator was detected or scanned by the time record system 100. In other embodiments, the signal may cause the wearable device to vibrate or produce a sound.

In an example embodiment, the signal is a short-range wireless signal and is transmitted to the wearable device at substantially the same time as the visual indicator is detected by an image sensing device.

In some embodiments, the device 420 or the server 430 receives an acknowledgment signal from the wearable device that is transmitted from the wearable device upon receipt of the indicator status signal. In one embodiment, the acknowledgement signal is generated following input from the employee. Receipt of the acknowledgement signal may be recorded in the database.

As a facility may have many active employees, the time record system 100 monitors for detection of multiple visual indicators, and tracks multiple visual indicators at a time. For example, the analysis module 130 may create and store a first event for a first detected visual indicator, and create and store another first event for a second detected visual indicator. Then the analysis module 130 monitors for a second detection for the first visual indicator and a second detection for the second visual indicator. The analysis module 130 may then determine the status of the employee identified by the first visual indicator and the status of the employee identified by the second visual indicator.

In an example embodiment, the alert module 150 generates an alert when the second event for a particular visual indicator is not detected within a pre-defined time period. In an example case, the analysis module 130 may determine that an employee exited the facility or entered a break room, but did not return to work from the break within pre-defined time period. The pre-defined time period may be different for each employee and may be stored in a database. In another example case, the analysis module 130 may determine that an employee has not clocked-out within a pre-defined time period (e.g., by the end of his or hers shift), in which case the alert module 150 may generate an alert.

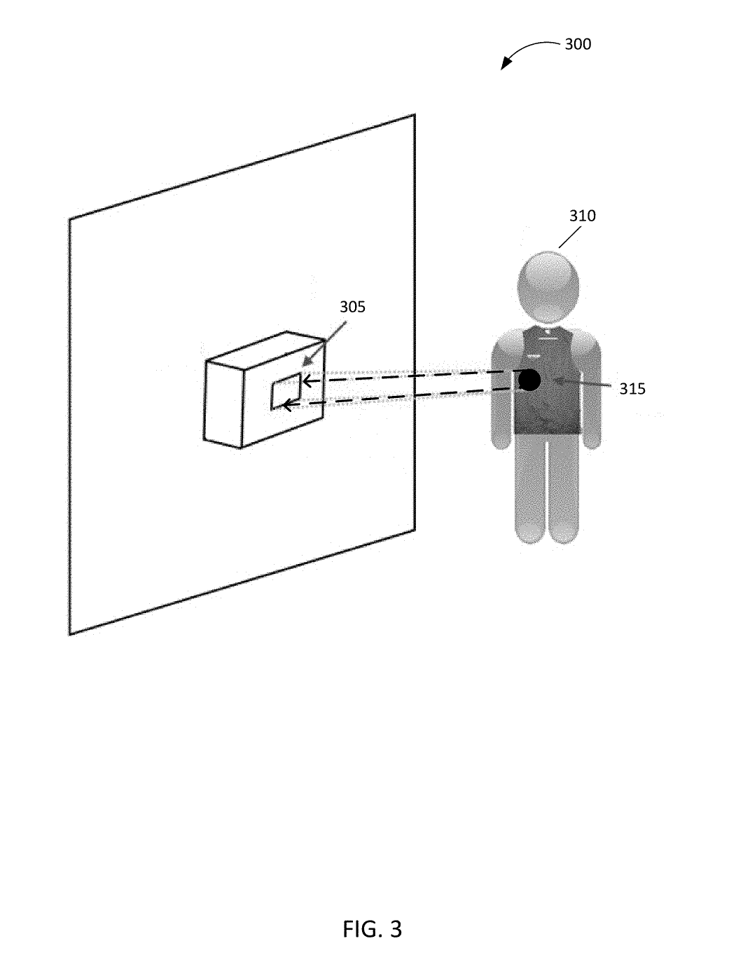

FIG. 3 schematically depicts an image sensing device in an exemplary time record system 300. As shown in FIG. 3, an image sensing device 305 is located on a wall. An employee 310 wears clothing having a visual indicator 315 affixed to it. The visual indicator 315 may be affixed at a chest of the employee, and the image sensing device 305 is positioned such that the visual indicator 315 can be detected when an employee stands in front of the image sensing device 305 or passes by the image sensing device 305.

FIG. 4 illustrates a network diagram depicting a system 400 for implementing the time record system described herein, according to an example embodiment. The system 400 can include a network 405, image sensing devices 410, wearable devices 415, a device 420, a server 430, and database(s) 440. Each of the image sensor devices 410, wearable devices 415, device 420, server 430, and database(s) 440 may be in communication with the network 405.

In an example embodiment, one or more portions of network 405 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The image sensing devices 410 are configured to detect a unique visual indicator affixed to an employee's clothing. The image sensing devices 410 may include, but are not limited to a camera, a video camera, infrared sensor, a multi-spectral sensor, x-ray, a CMOS sensor, a CCD sensor, and the like. The image sensing devices 410 may connect to network 405 via a wired or wireless connection. The image sensing device 410 may be the image sensing device 305 of FIG. 3. The image sensing devices 410 may connect to network 405 via a wired or wireless connection.

The wearable devices 415 may include, but are not limited, to security badges, name badges, smartwatches, fitness trackers or devices, and other wearable devices. The wearable device may include wireless or Bluetooth communication capabilities. The wearable device can receive a signal from an image sensing device, a device, a serve, or other device.

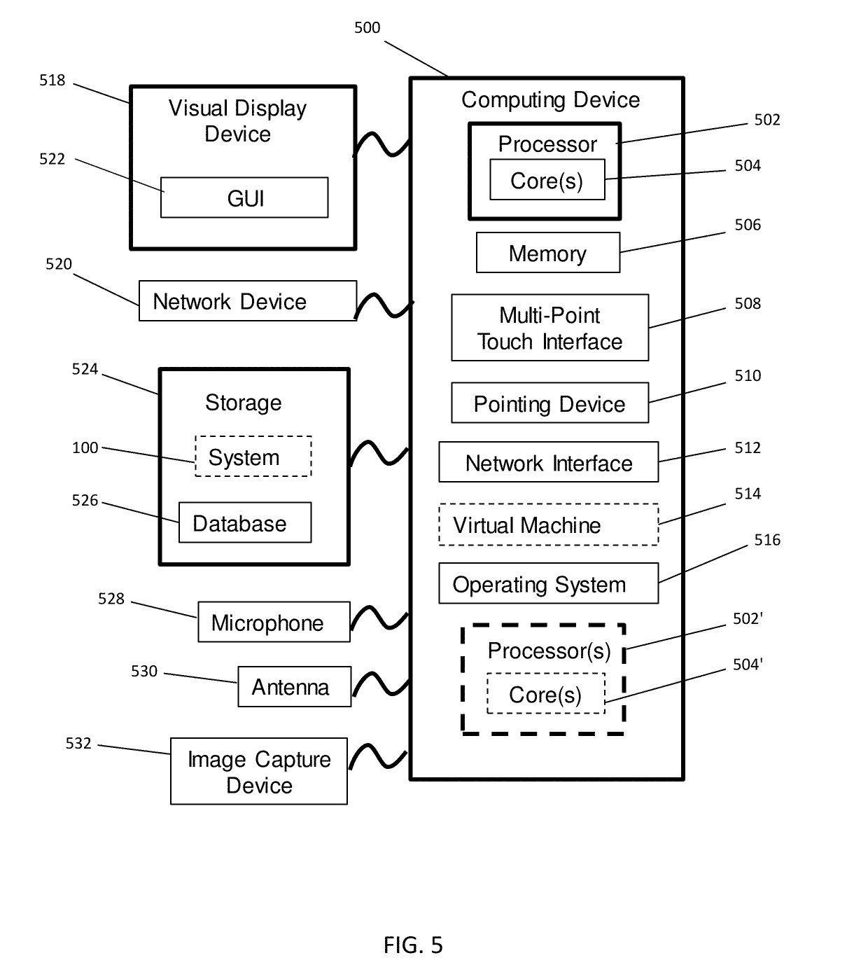

The device 420 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, and the like. The device 420 can include one or more components described in relation to computing device 500 shown in FIG. 5.

The device 420 may connect to network 405 via a wired or wireless connection. The device 420 may include one or more applications or systems such as, but not limited to, a web browser, an employee management application, an employee time recorder based on the time record system described herein, and the like. In an example embodiment, the device 420 may perform some of the functionalities described herein. In an example embodiment, the device 420 may be used to access employee clock-in and clock-out records. The device 420 may also receive alerts generated by the time record system to alert a manager regarding an employee.

Each of the database(s) 440 and server 430 is connected to the network 405 via a wired or wireless connection. Server 430 may include one or more computers or processors configured to communicate with the image sensor devices 410 and/or the device 420 via network 405. Server 430 hosts one or more applications accessed by device 420 and/or facilitates access to the content of database(s) 440. The server 430 may perform some of the functionalities of the time record system described herein. Database(s) 440 may include one or more storage devices for storing data and/or instructions (or code) for use by server 430, and/or device 420. Database(s) 440 and server 430 may be located at one or more geographically distributed locations from each other or from device 420 and image sensor devices 410. Alternatively, database(s) 440 may be included within server 430.

FIG. 5 is a block diagram of an exemplary computing device 500 that can be used to perform the methods provided by exemplary embodiments. The computing device 500 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 506 included in the computing device 500 can store computer-readable and computer-executable instructions or software for implementing exemplary embodiments. The computing device 500 also includes processor 502 and associated core 504, and optionally, one or more additional processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ can each be a single core processor or multiple core (504 and 504′) processor.

Virtualization can be employed in the computing device 500 so that infrastructure and resources in the computing device can be shared dynamically. A virtual machine 514 can be provided to handle a process running on multiple processors so that the process appears to be using only one computing resource rather than multiple computing resources. Multiple virtual machines can also be used with one processor.

Memory 506 can include a computer system memory or random access memory, such as DRAM, SRAM, EDO RAM, and the like. Memory 506 can include other types of memory as well, or combinations thereof.

An employee can interact with the computing device 500 through a visual display device 518, such as a touch screen display or computer monitor, which can display one or more user interfaces 519 that can be provided in accordance with exemplary embodiments. The visual display device 518 can also display other aspects, elements and/or information or data associated with exemplary embodiments. The computing device 500 can include other I/O devices for receiving input from an employee, for example, a keyboard or other suitable multi-point touch interface 508, a pointing device 510 (e.g., a pen, stylus, mouse, or trackpad). The keyboard 508 and the pointing device 510 can be coupled to the visual display device 518. The computing device 500 can include other suitable conventional I/O peripherals.

The computing device 500 can also include one or more storage devices 524, such as a hard-drive, CD-ROM, or other computer readable media, for storing data and computer-readable instructions and/or software, such as the system 100 that implements exemplary embodiments of the sensor system described herein, or portions thereof, which can be executed to generate user interface 519 on display 518. Exemplary storage device 524 can also store one or more databases for storing suitable information required to implement exemplary embodiments. The databases can be updated by an employee or automatically at a suitable time to add, delete or update one or more items in the databases. Exemplary storage device 524 can store one or more databases 526 for storing data detected by the image sensing devices, location of the image sensing devices, employee information (name, job title, work schedule, unique visual indicator, wearable device), events created by the time record system, status of an employee, and other data/information used to implement exemplary embodiments of the systems and methods described herein.

The computing device 500 can include a network interface 512 configured to interface via one or more network devices 522 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of the above. The network interface 512 can include a built-in network adapter, network interface card, PCMCIA network card, card bus network adapter, wireless network adapter, USB network adapter, modem or another device suitable for interfacing the computing device 500 to a type of network capable of communication and performing the operations described herein. Moreover, the computing device 500 can be a computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 500 can run operating systems 516, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or another operating system capable of running on the computing device and performing the operations described herein. In exemplary embodiments, the operating system 516 can be run in native mode or emulated mode. In an exemplary embodiment, the operating system 516 can be run on one or more cloud machine instances.

The following description is presented to enable a person skilled in the art to create and use a computer system configuration and related method and systems for an employee time record system to automatically determine an on-the-clock status (clock-in or clock-out) of an employee. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components or steps can be replaced with a single element, component or step. Likewise, a single element, component or step can be replaced with multiple elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

What is claimed is:

1. An employee time record system for determining status of an employee, the system comprising:
a plurality of image sensing devices positioned at one or more locations in a physical facility;
a visual indicator affixed to clothing uniquely identifying an employee; and
a processor in a processing device in communication with the plurality of image sensing devices,
wherein the plurality of image sensing devices are configured to:
detect the visual indicator, and
wherein the processing device is configured to:
create and store a first event in a database in response to a first detection of the visual indicator, the first event indicating the first detection of the visual indicator by at least one of the plurality of image sensing devices and a timestamp for when the first detection occurred;
monitor for occurrence of a second detection of the visual indicator by one of the plurality of image sensing devices, the second detection occurring after the first detection,
create and store a second event in the database in response to the second detection, the second event indicating the second detection of the visual indicator by at least one of the plurality of image sensing devices and a timestamp for when the second detection occurred,
determine a status of the employee identified by the visual indicator based at least in part on an occurrence of at least one of the first event and the second event, and
transmit a signal to a wearable device associated with the employee indicating the status determined for the employee.

2. The system of claim 1, wherein the processor is configured to:
generate an alert when the second event is not detected within a pre-defined time period.

3. The system of claim 1, further comprising:
a database storing a location of each of the plurality of image sensing devices, wherein the determining of the status is based at least in part on a location of where at least one of the first and second detection occurred.

4. The system of claim 1, further comprising:
a database storing employee information including name and job title, wherein the determining of the status is based at least in part on a job title of the employee.

5. The system of claim 1, wherein the determining of the status is based on an elapsed time occurring between the first event and second event.

6. The system of claim 1, wherein the visual indicator is a holographic image affixed to clothing worn by the employee.

7. The system of claim 1, wherein the visual indicator is a light-reflective patch affixed to clothing worn by the employee.

8. The system of claim 1, wherein the status of the employee is recorded as one of clocked-in, clocked-out, or on-break.

9. The system of claim 1, wherein the signal is transmitted to the wearable device causes a light circuit to activate at the wearable device.

10. The system of claim 1, wherein the signal is a short-range wireless signal.

11. The system of claim 1, wherein the processing device is configured to receive an acknowledgment signal from the wearable device inputted by the employee.

12. A method for determining a status of an employee in an employee time record system, the method comprising:
disposing a plurality of image sensing devices at one or more locations in a physical facility;
affixing a visual indicator to clothing uniquely identifying an employee;
detecting the visual indicator with one of the plurality of image sensing devices;
creating and storing a first event in a database in response to a first detection of the visual indicator, the first event indicating the first detection of the visual indicator by at least one of the plurality of image sensing devices and a timestamp for when the first detection occurred;
monitoring for occurrence of a second detection of the visual indicator by one of the plurality of image sensing devices, the second detection occurring after the first detection;
creating and storing a second event in a database in response to the second detection of the visual indicator, the second event indicating the second detection of the visual indicator by at least one of the plurality of image sensing devices and a timestamp for when the second detection occurred;
determining a status of the employee identified by the visual indicator based at least in part on an occurrence of at least one of the first event and the second event; and
transmitting a signal to a wearable device associated with the employee indicating the status determined for the employee.

13. The method of claim 12, further comprising:
generating an alert when the second event is not detected within a pre-defined time period.

14. The method of claim 12, further comprising:
storing a location of each of the plurality of image sensing devices in a database, wherein the determining of the status is based at least in part on a location of where at least one of the first and second detection occurred.

15. The method of claim 12, further comprising:
storing employee information including name, and job title, wherein the determining of the status is based at least in part on a job title of the employee.

16. The method of claim 12, wherein the determining of the status is based on an elapsed time occurring between the first event and the second event.

17. The method of claim 12, wherein the status of the employee is recorded as one of clocked-in, clocked-out, or on-break.

18. The method of claim 12, further comprising:
receiving an acknowledgment signal from the wearable device inputted by the employee.

19. A non-transitory computer readable medium storing instructions that when executed by a processor causes the processor to implement a method for determining status of an employee in an employee time record system, the method comprising:
detecting a visual indicator affixed to clothing that uniquely identifies an employee with one of a plurality of image sensing devices positioned at one or more locations in a physical facility;
creating and storing a first event in a database in response to a first detection of the visual indicator, the first event indicating the first detection of the visual indicator by at least one of the plurality of image sensing devices and a timestamp for when the first detection occurred;
monitoring for occurrence of a second detection of the visual indicator by one of the plurality of image sensing devices, the second detection occurring after the first detection;
creating and storing a second event in a database in response to the second detection of the visual indicator, the second event indicating the second detection of the visual indicator by at least one of the plurality of image sensing devices and a timestamp for when the second detection occurred;
determining a status of the employee identified by the visual indicator based at least in part on an occurrence of at least one of the first event and the second event,
transmitting a signal to a wearable device associated with the employee indicating the status determined for the employee.

20. The non-transitory computer readable medium of claim 19, wherein the method further comprises storing a location of each of the plurality of image sensing devices in a database, wherein the determining of the status is based at least in part on a location of where at least one of the first and second detection occurred.
